(19) United States
(12) Patent Application Publication
(10) Pub. No.: US 2015/0108766 A1
(43) Pub. Date: Apr. 23, 2015

(54) ALFA 1 Fuel less Power Generating System

(71) Applicant: Regnault Bamiji, Jos (NG)

(72) Inventor: Regnault Bamiji, Jos (NG)

(21) Appl. No.: 14/058,687

(22) Filed: Oct. 21, 2013

(51) Int. Cl. H02K 33/00; H02K 7/18; H01F 7/02

(52) U.S. Cl. CPC H02K 33/00; H01F 7/0231; H02K 7/1815; H02K 53/00
USPC 290/1 A; 310/20; 74/DIG. 9

(57) ABSTRACT

The current invention is an Alfa 1 fuel less power generator is a radical departure from the present day forms of power generating systems, because, it is an absolute departure from the present form of power generating systems we know today. All together fuel less in nature, that operated as stand alone system, or self sustained, requiring no external support of Sun, Wind, Fossil fuel, Hydro power system, and battery to charge as do inverters or any form of hydro carbon. The ALFA 1 Fuel-less Power generating system, uses a reciprocating system, but this time around, the system is not powered by any fuel but permanent magnets(Repulsive force as fuel) having a repelling force of 120 kg, which are repelling each other whenever they come close to each other.

### BACKGROUND OF INVENTION

1. Field of the Invention

This invention related fuel less power generating system, where power generation will be affordable, dependable, cheap and available when needed, it helps preserved our environment because there is no exhaust fumes given out as do the present form of power generating system.

2. Background

It is a system that combines, the use of permanent magnets, with a repelling force of 120 kg that works in a reciprocating motion, supported by heavy flywheel, rectifier and automatic change over switch that switch over from the battery, after starting to a rectifier supply of DC power to keep system in motion.

### SUMMARY OF THE INVENTION

The present invention is to supply power without the use of fossil fuel, solar power, inverter, wind power, hydro power or fuel cell.

It does not need any geographical or geological features to operate, and most of all, maintenance free, as compared to the present form of power generating system.

### ADVANTAGES

It is an all weather system that does not require the Sun, Wind, change in water level as do hydro power system. There is no fear of fire hazard, since it has not fuel to consume. It helps to keep our environment healthy without form of pollution.

Further features and advantages of the invention will become apparent from the following detailed description made with reference to the accompanying drawings.

### BRIEF DESCRIPTION OF THE DRAWINGS

Without restricting the full scope of this invention, the preferred form of this invention is illustrated in the following drawings:

FIG. 1 display the best embodiment of the present invention.

### BRIEF DESCRIPTION OF THE PREFERRED EMBODIMENTS

There are a number of significant design features and improvements incorporated within the invention.

The Alpha 1 fuel less power generator is the solution to present day global outcry for safe power generating system that is environmentally friendly, no exhaust or toxic fumes that pollute the environment. It is durable and requires little maintenance while achieving optimum performance, giving you peace of mind without the anticipation of any form of fire disaster from the system itself.

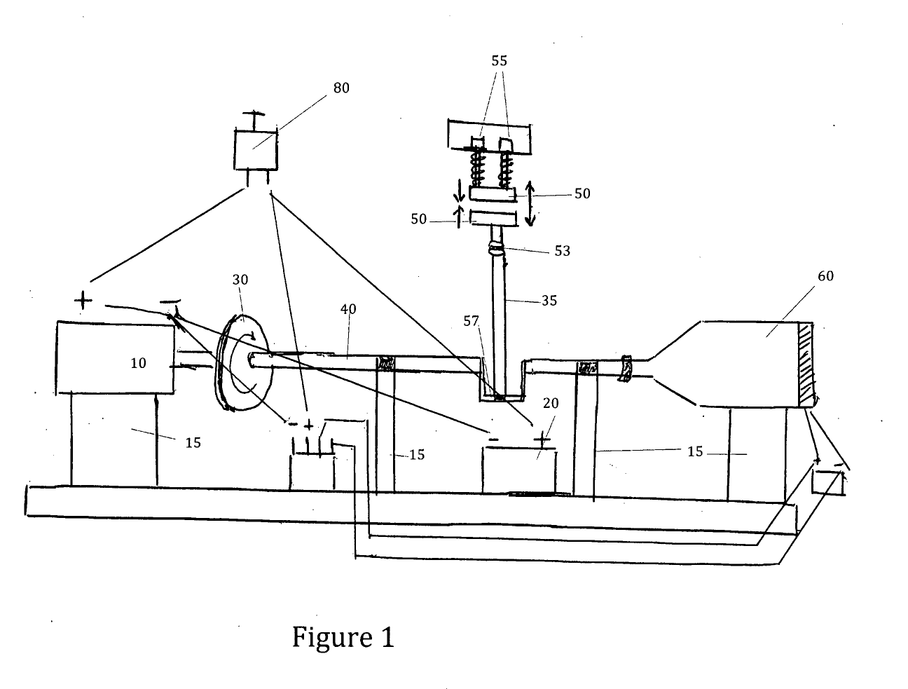

It works, as shown in FIG. 1, when the DC motor 10 receives current from the battery 20, it begins to rotate at 3600 rpm, this rotation is transferred to the flywheel 30 through a shaft 40, as the fly wheel 30 begin to rotate, it forces the permanent magnets 50 facing each other to close, thereby repelling each other at a force of 150 kg, the force of this repulsion cause the flywheel 30 to return to its starting point (at this time, the cylindrical magnets 50 facing each other are in open position) on returning the momentum of the heavy flywheel 30 force the magnets 50 to repel again, these mechanical motions are sustained not to come to a halt by the force of rotation from the DC motor 10.

One of the permanent magnets 50 is connect to a compression spring 53 which is connected to a bar 35 and connected to the shaft 40 through a knuckle joint 57 with the other permanent magnet positioned next to it connected to a compression spring 54 connected to a stopper 55/fixed holder. The knuckle joint 57 causes the bar 35 with the permanent magnet 50 to move up and down when the shaft 40 rotates.

The DC motor 10 is now feed by voltage from the already working alternator 60 via a 12V 50 A rectifier 70 (not battery), the battery 20 at this time is dormant, but only receive charging voltage (12V) from the rectifier 70, with this mechanical motions, the system continue rotating non-stop (completing a circle and starting again) until the Universal transfer switch 80 is turn to off position.

As soon as the light bulb comes up which was connected to the alternator 60, the universal transfer switch 80 is manually switch to position 2, this disconnect the voltage from the battery 20 that feeds the DC motors 10, and connect the DC motor 10 to the rectifier 70.

Finally these rotations are transmitted via a shaft 40 to an alternator 60 and the alternator 60 gives out voltage 230 volts, 50 Hz at 3600 rpm.

The DC motor 10 is now feed by voltage from the already working alternator 60 via a 12V 50 A rectifier 70, with this mechanical motions, the system continue rotating non-stop(completing a circle and starting again) until the Universal transfer switch 80 is turn to off position.

The shaft 40, DC motor 10 and alternator 60 can be positioned on stands 15.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Other types of panels can be used besides the SICP panels with the current invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1-3. (canceled)

4. A fuel less power generating system comprising: A universal transfer starter switch, connected to a 12V battery, 12V DC motor, stainless steel shaft, heavy flywheel, powerful permanent magnets and alternator, When the universal starter switch is switched ON, the 12V battery supply voltage to the 12 DC motor causing it to spin at initial speed of 3600 rpm, a DC motor is connected to a heavy flywheel via a stainless steel shaft, As the heavy flywheel spins, it causes the repelling permanent magnets facing each other to close the gabs between them as a result the permanent magnets now repel themselves so powerfully to force the heavy flywheel to rotate again, The heavy flywheel and the two powerful permanent magnets mutually supports each other in a reciprocating motion to keep the system in continuous mechanical motion, the other end of the main stainless steel shaft is connected via a universal joint to an alternator spinning now at 3200 rpm instead of the initial 3600 rpm due to energy lost, producing 220V 50 Hz of electricity.

5. A fuel less power generating system consisting: A system that is self-sustained without the need of any external source such as fossil fuel, hydro, Wind or Solar to operate, It is an all location installation system without the need or presence of any geographical features (Sun, Wind, and Water) to operate, neither does it depend on charging battery or battery voltage to sustain the system as do inverters.

6. A fuel less power generating system that is maintenance free: A system that is absolutely maintenance free, starts at any time when keep for long time, without the need for servicing of parts and component first, Can be keep for a long time and restarted when needed without the need for oil and fuel for lubrication.

7. A device according to claim 6 further comprising: an universal transfer starter switch, a battery, a DC motor, stainless steel shaft, heavy flywheel, powerful permanent magnets and alternator, where when the universal starter switch is switched ON, the battery supplies voltage to the DC motor causing it to spin at initial speed of 3600 rpm, the DC motor is connected to a stainless steel shaft which is connected to a heavy flywheel, with a plurality of repelling magnets connected to the shaft by a knuckle joint with a set of plurality of magnets connected to a fixed point by springs that are positioned across from the first set of batteries with the shaft is connected to an alternator.
